(19) United States
(12) Patent Application Publication
(10) Pub. No.: US 2024/0303674 A1
(43) Pub. Date: Sep. 12, 2024

(54) SYSTEM AND METHOD OF PRODUCT AUTHENTICATION AND PRODUCTION TRACKING

(71) Applicant: Benyamin Abehasera, Hallandale Beach, FL (US)

(72) Inventor: Benyamin Abehasera, Hallandale Beach, FL (US)

(21) Appl. No.: 18/181,652

(22) Filed: Mar. 10, 2023

(51) Int. Cl. G06Q 30/018; G06K 1/12; G06K 7/14; G06K 19/06; G06Q 30/012

(52) U.S. Cl. CPC G06Q 30/0185; G06K 1/12; G06K 7/1417; G06K 19/06037; G06Q 30/012

(57) ABSTRACT

A computer-implemented product authentication system and method including software that allows for the automatic creation and storage of serial number QR codes. The invention addresses the problems of distinguishing genuine products from counterfeit products and losing track of product warranty registrations. The invention's QR code creation and storage process ensures that counterfeit products will be detected and ensure that product warranties are honored. The invention includes a platform host in communication to a plurality of devices, databases, and software.

### FIELD OF INVENTION

The present invention relates generally to computer-implemented system and method of product authentication utilizing a platform host in communication with array of devices.

### BRIEF DESCRIPTION OF THE DRAWINGS

Those of skill in the art will recognize that the following description is merely illustrative of the principles of the disclosure, which may be applied in various ways to provide many different alternative embodiments. This description is made for illustrating the general principles of the teachings of this disclosure invention and is not meant to limit the inventive concepts disclosed herein.

The accompanying drawings, which are incorporated in and constitute a part of the specification, illustrate embodiments of the disclosure and together with the general description of the disclosure given above and the detailed description of the drawings, given below, explain the principles of the disclosure.

In the drawings:

FIG. 1 is a system environment, according to an embodiment.

FIG. 2 describes a method for using the manufacturer application, according to an embodiment.

FIG. 3 describes a method for using the mobile application, according to an embodiment.

FIG. 4 describes a method for using the support application, according to an embodiment.

The drawings are not necessarily to scale. In certain instances, details that are not necessary for an understanding of the disclosure or that render other details difficult to perceive may have been omitted. It should be understood, of course, that the disclosure is not necessarily limited to the embodiments illustrated herein.

### DETAILED DESCRIPTION

The present invention provides its benefits across a broad spectrum of endeavors. It is applicant's intent that this specification and the claims appended hereto be accorded a breadth in keeping with the scope and spirit of the invention being disclosed despite what might appear to be limiting language imposed by the requirements of referring to the specific examples disclosed. Thus, to acquaint persons skilled in the pertinent arts most closely related to the present invention, a preferred embodiment of the system is disclosed for the purpose of illustrating the nature of the invention. The embodiments described herein are illustrative, and as will become apparent to those skilled in the art, can be modified in numerous ways within the scope and spirit of the invention, the invention being measured by the appended claims and not by the details of the specification.

Although the following text sets forth a detailed description of numerous different embodiments, the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined herein, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, subparagraph (f).

### Overview of Product Authentication System

The present invention comprises various embodiments of a computer-implemented product authentication system including (1) a platform host; (2) software; (3) computing devices; (4) mobile devices; and (5) QR code applicators. The invention addresses the common problems of distinguishing a genuine product from counterfeit products and losing track of product warranty registrations. The invention's QR code database ensures that consumers and retailers will not be tricked by fake products and ensures that warranties on products can be tracked correctly. The invention differs from traditional product authentication and warranty tracking systems because it is a closed loop system that randomly creates and automatically tests QR codes to determine the authenticity of a product. Once a new QR code is randomly created, the QR code applicator marks a product with the QR code, and the code is stored in the platform host as that product's individual serial number. In some embodiments, the QR applicator includes a laser machine, a printer, or an engraver. In some embodiments, a QR code is marked on a product during production of the product to allow for production tracking. In some embodiments, the product authentication system is available 24 hours a day, 365 days a year.

In some embodiments, the platform host is made available to various types of users on a variety of applications. In some embodiments, the applications include the Manufacturer App, Support App, Admin App, Manager App, and Mobile Apps. In some embodiments, the types of users include Operators, Managers, Admins, and Users. The Admin App allows Admins to create Managers and search product notes by specifying the date range and Operator. The Manager App allows Managers to create Operators. The Manufacture App is responsible for generating new serial number QR codes. After an Operator scans the QR code marked on the product, Manufacture App compares it with the generated code and if the code is the stock-keeping unit code, the QR code is scanned. Then the Manufacture App stores the result in Cloud Server database, or in Local database if there is no Internet available at the time of storage. In some embodiments, if the storage process fails at any step the app stored the generated QR code in the Defective database (on Cloud Server or Local database).

Users utilize the mobile apps for warranty registration. Users have to scan the QR code on the device using a mobile device camera and the mobile app checks the Cloud server for the code. The cloud server checks that there is no registration for the device and permits a mobile app to continue to the registration form. After the user fills out and sends the registration form to the server, the server generates the code and sends a message to the user device for phone number verification. After the user receives the message and enters the code, the application registers the product in the database of cloud server and sends a confirmation email. The Mobile Apps are executable on a variety of operating systems, including Android and iOS. The Support App is used to scan User product serial numbers, sent by email or any other means, to customer support. Once the QR code is scanned, the support app shows the user's personal data with all previous product notes and attachments. The support app also allows customer support to add another note with a single attachment. In some embodiments, each attachment can be any file with a size limit of 5 MB.

Operators are responsible for running the Manufacturer App and are created by Managers. Managers are responsible for the creation of Operators and are created by Admins. Admins are responsible for creating Managers. Users are registered product owners. In some embodiments, the software allows Users to register for a product warranty by scanning a product QR code using a mobile device camera. In some embodiments, the invention is also enabled with a cyber security system that monitors and alerts if a cyberattack has been detected.

### Network-Enabled Platform Host

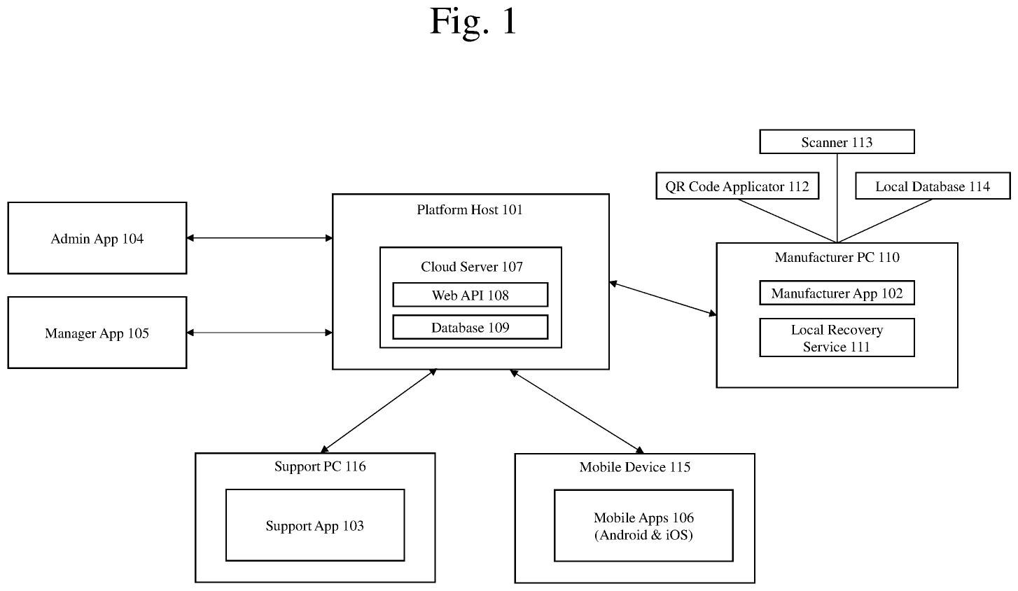

FIG. 1 illustrates one embodiment of an information system that facilitates management and execution of the system methods described herein. The system includes a platform host 101, software (102, 103, 104, 105, 106), at least one or more QR code applicators 112, and at least one or more computing devices (110, 115, 116) that allow users to communicate with the platform host 101. The software (102, 103, 104, 105, 106), computing devices (110, 115, 116), and the platform host 101 are in data communication over a communications network such that the computing devices (110, 115, 116) and software (102, 103, 104, 105, 106) can access the platform host 101 to send and receive data thereto and therefrom. In some embodiments, the communications network comprises the Internet, cellular network, satellite network, RF communication, blue-tooth type communication, near field, or any other form of communication network capable of facilitating communication between the computing devices (110, 115, 116), software (102, 103, 104, 105, 106), and the platform host 101. The system, in some embodiments, comprises an internet-enabled computing system whereby the computing devices (110, 115, 116) and the software (102, 103, 104, 105, 106) access an online and internet-based platform served by the platform host 101. In some embodiments, the platform host 101 hosts an interactive graphical user interface and facilitates and carries out the methods described herein.

A communications link is established between the software (102, 103, 104, 105, 106), a plurality of computing devices (110, 115, 116), and the platform host 101. The platform host 101 receives a request from one or more user devices to establish an account. In some embodiments, the platform host 101 assigns a role to each registered user, including an “Admin,” a “Manager,” an “Operator,” and a “User.”

In some embodiments, the platform host 11 makes available a graphical user interface based on the account data points, which user interface includes a plurality of product authentication functions.

The system and method described herein can be delivered in a variety of ways including via a desktop application, a mobile application, through a wide area network, such as a cloud-based or online computing environment, or through a local area network. Accordingly, the system is designed and flexible and scalable with various formats of user devices including personal computers, tablets, mobile devices, and virtual devices.

### Method of QR Code Creation and Storage

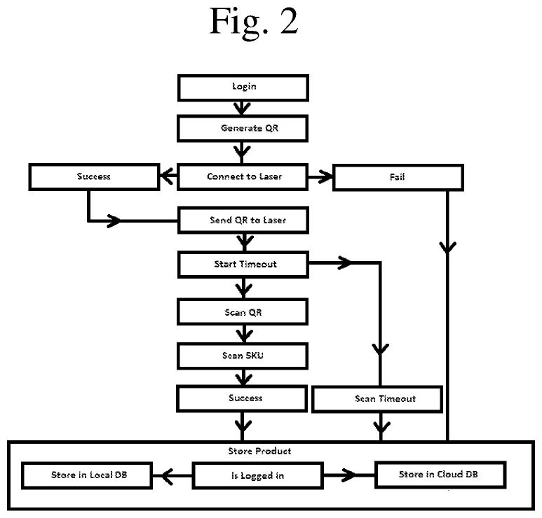

FIG. 2 illustrates an example of the method steps associated with one embodiment of the invention. In some embodiments, a computing device 110 in data communication with the platform host 101 executes the software 102, the software 102 automatically generates a random QR code. The computing device 110 then sends the QR code applicator 112 instructions to mark a product with the newly generated QR code. The QR code applicator 112 receives the instructions from the computing device 110 and marks the product with the newly generated QR code. A scanner 113, in data communication with the computing device 110, scans the QR code on the product. The software 103 then transfers the QR code to the platform host 101 where the QR code is stored as the product's serial number. In some embodiments, the QR code applicator 112 includes a printer, an engraver, or a laser machine. In some embodiments, if the storage of the QR code fails at any step of the process, the QR code is stored in a database for deflective QR codes on the platform host 101.

In some embodiments, the QR code is stored in a local database 114 if the computing device 110 is not connected to the Internet at the time of storage. In some embodiments, the computing device 110 is executing the software 111. The software 111 periodically checks the local database 114 for product data. If the software 111 detects product data in the local database 114 while the computing device 110 is connected to the Internet, the software 111 stores the product data detected in the local database 114 on the platform host 101. In some embodiments, the software 111 is called the Local Recovery Service. As noted above, in some embodiments system users are assigned a role, with one of those being the Operator. Operators are responsible running the software 102 that creates and stores the newly created QR codes. In some embodiments, the software 102 that creates and stores the new QR code is called the Manufacture App 102. In some embodiments, the system can automatically create and store the newly generated QR codes. In some embodiments, the creation and storage of the newly generated QR codes may be carried out manually through user input. Still yet, in some embodiments, the creation and storage process can be carried out through artificial intelligence by configuring the platform host 101 with machine learning functionality, either locally or remotely. In some embodiments, a QR code is marked on a product during production of the product to allow for production tracking.

### Method of User Product Warranty Registration

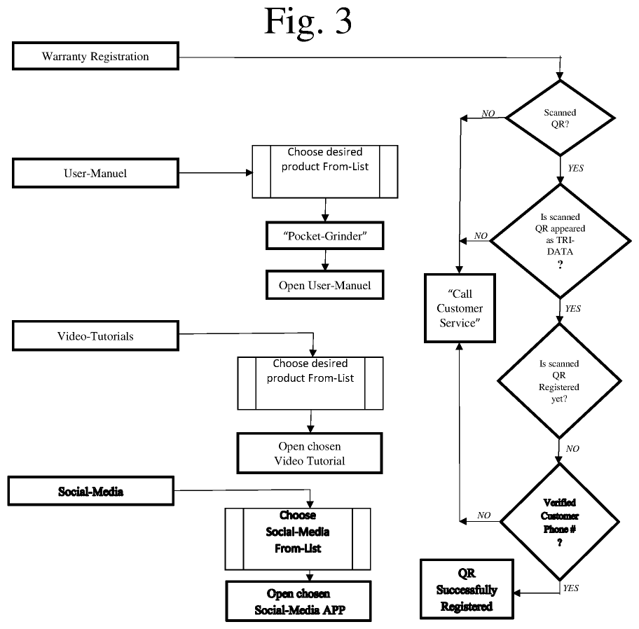

With reference to FIG. 3, shown is an example of the method steps associated with one embodiment of the invention. In some embodiments, a computing device 115 in data communication with the platform host 101 executes the software 106, the software 106 allowing a camera of the computing device 115 to scan a product QR code. Once the QR code is scanned, the software 106 checks the database 109 to determine if the QR code is registered on the platform host 101. In some embodiments, if the product QR code is not registered on the platform host 101, the cloud server 107 generates a verification code and sends the code to the computing device 115 for user verification. In some embodiments, the verification code can be sent via SMS to a computing device 115 executing the software 106. Once the user inputs the verification code sent from the cloud server 107 into the software 106, the software 106 registers the scanned product QR code in the database 109. In some embodiments, the software 106 is executable on a variety of operating systems, including Android and iOS.

### Method of Customer Support

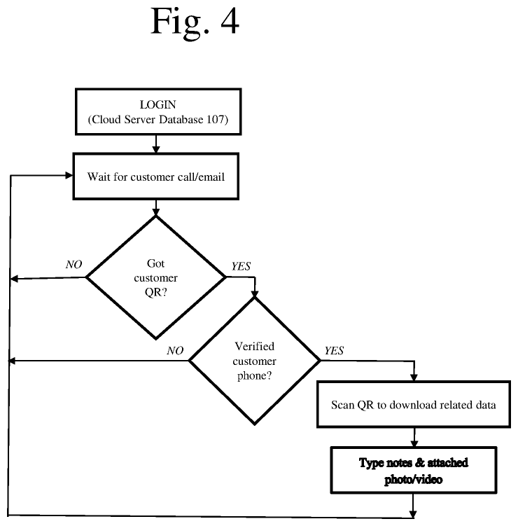

FIG. 4 illustrates a method of customer support, in an embodiment. In some embodiments, a computing device 116 in data communication with the platform host 101 executes the software 103. A user provides customer support with a product QR code via email or other means. In some embodiments, customer support verifies the phone number of the user before scanning the QR code. The software 103 scans the QR code provided by the customer and then displays notes and attachments related to the QR code on the computing device 116. In some embodiments, customer support can add notes and attachments to the data related to the QR code. In some embodiments, each attachment can be any file with a size limit of 5 MB.

### Explanation of Computing Environment

In some embodiments, the computing environment of the present invention includes the computing systems of the computing devices (110, 115, 116). The computing devices (110, 115, 116) can send and receive data and information. The computing systems of the computing devices (110, 115, 116) correspond to the platform host 101 that can also send and receive data and information. The computing devices (110, 115, 116) can include any smart phone, tablet computer, laptop computer, or other computing or mobile device capable of reading, and/or recording data about systems, devices, locations, and/or equipment, etc. The computing systems of the computing devices (110, 115, 116) can include any server computer, desktop computer, laptop computer, or other device capable of storing and managing data communication by and between one or more computing systems. Any of the computing devices (110, 115, 116) can be capable of accomplishing any of the steps of functions described in this description.

The computing devices (110, 115, 116) can include processing systems, storage systems, software, communication interfaces, and user interfaces. The processing system can load and execute software (102, 103, 104, 105, 106) from a storage system. When executed by the computing devices (110, 115, 116), the software (102, 103, 104, 105, 106) directs a processing system to receive data, images, devices, locations, and/or equipment, etc. Such data could include any of the information described above, including but not limited to the functionality described herein.

Additionally, the computing devices (110, 115, 116) can include a communication interface that can be further configured to transmit data to and receive data from other computing devices using a communication network. The communication network could include the Internet, cellular network, satellite network, RF communication, blue-tooth type communication, near field, or any other form of communication network capable of facilitating communication between the computing devices (110, 115, 116).

The processing system of the computing devices (110, 115, 116) can comprise a microprocessor and other circuitry that retrieves and executes software (102, 103, 104, 105, 106). The processing system can be implemented within a single processing device but can also be distributed across multiple processing devices or sub-systems that cooperate in executing program instructions. Examples of the processing system include general purpose central processing units, application specific processors, and logic devices, as well as any other type of processing device, combinations of processing devices, or variations thereof.

The storage system of the computing devices (110, 115, 116) can comprise any storage media readable by the processing system, and capable of storing software (102, 103, 104, 105, 106) and data from the computing devices (110, 115, 116). Data from the computing devices (110, 115, 116) may be stored in a word, excel, or any other form of digital file. The storage system can include volatile and nonvolatile, removable and non-removable media implemented in any method or technology for storage of information, such as computer readable instructions, data structures, program modules, or other data. The storage system can be implemented as a single storage device but may also be implemented across multiple storage devices or sub-systems.

The storage system can comprise additional elements, such as a controller, capable of communicating with the processing system. Examples of storage media include random access memory, read only memory, magnetic disks, optical disks, flash memory, virtual memory, and non-virtual memory, magnetic cassettes, magnetic tape, magnetic disk storage or other magnetic storage devices, or any other medium which can be used to store the desired information and that may be accessed by an instruction execution system, as well as any combination or variation thereof, or any other type of storage media. In some implementations, the storage media can be a non-transitory storage media. In some implementations, at least a portion of the storage media may be transitory. In no case is the storage media a propagated signal.

The application interface of the computing devices (110, 115, 116) can include data inputs and image displays. In one example, the data inputs can be used to collect information and data inputs from the user.

In some embodiments, the computing devices (110, 115, 116) can include a user interface. The user interface can include a mouse, a keyboard, a voice input device, a touch input device for receiving a gesture from a user, a motion input device for detecting non-touch gestures and other motions by a user, and other comparable input devices and associated processing elements capable of receiving user input from a user. Output devices such as a graphical display, speakers, printers, haptic devices, and other types of output devices may also be included in the user interface. The user input and output devices are well known in the art and need not be discussed at length here.

The included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the disclosure.

Moreover, though the present disclosure has included description of one or more embodiments and certain variations and modifications, other variations and modifications are within the scope of the disclosure, e.g., the use of a certain component described above alone or in conjunction with other components may comprise a system, while in other aspects the system may be the combination of all of the components described herein, and in different order than that employed for the purpose of communicating the novel aspects of the present disclosure. Other variations and modifications may be within the skill and knowledge of those in the art, after understanding the present disclosure. This method of disclosure is intended to obtain rights which include alternative embodiments to the extent permitted, including alternate, interchangeable and/or equivalent structures, functions, ranges or steps to those claimed, whether such alternate, interchangeable and/or equivalent structures, functions, ranges or steps are disclosed herein, and without intending to publicly dedicate any patentable subject matter.

What is claimed is:

1. A method of serial number QR code creation and storage, comprising:
on a platform host, establishing a communications link with software and a plurality of devices comprising computing devices, scanners, and a QR code applicator;
executing the software on a computing device;
generating, via the software, a serial number QR code;
establishing a communications link between the computing device and the QR code applicator;
sending, from the computing device, data corresponding to the QR code generated from the software to the QR code applicator;
receiving on the QR code applicator the data corresponding to the QR code;
marking the product, via the QR code applicator, with the QR code transmitted from the computing device;
establishing a communications link between the scanner and the software;
scanning the QR code marked on the product with the scanner;
comparing, via the software, the QR code to the generated code, if the code is correct the scanner then scans a stock keeping unit;
storing the result as the product's individual serial number on the platform host via the software.

2. The method of claim 1, wherein the result is stored in the local database of the computing device if there is not internet present at the time of result storage.

3. The method of claim 1, wherein the platform host is network enabled.

4. The method of claim 1, wherein the serial number QR code creation and storage functions via a local area network.

5. The method of claim 1, wherein the QR code is applied by a printer, engraver, or laser.

6. The method of claim 1, wherein the serial QR code is randomly generated by the software.

7. The method of claim 1, wherein failure at any step of the storage process leads the software to store the generated QR code in a database for deflective QR codes on the platform host.

8. The method of claim 7, wherein the result is stored in the local database instead of the deflective QR code database on the platform host if there is not internet present at the time of result storage.

9. The method of claim 2, wherein the software periodically checks if there is any product data in the local database.

10. The method of claim 9, wherein when the software detects product data in the local database, the software stores that product data on the platform host when the system is connected to the internet.

11. The method of claim 1, wherein the QR code is marked on the product during production of the product to allow for production tracking.

12. A method of user product warranty registration, comprising:
on a platform host, establishing a communications link with software and a computing device integrated with a camera;
executing the software on the computing device;
scanning the QR code on the product using the camera on the computing device;
sending the QR code to the platform host via the software;
checking the platform host to determine the registration status for the device, if the product QR code is not registered the platform host permits the software to display a registration form on the computing device;
completing the registration form via the software;
sending the completed registration form to the platform host via the software;
generating a code for verification via the platform host;
sending via the platform host a message containing the generated code to the user computing device;
receiving the message on the user computing device;
entering the generated code in the message into the software;
registering the product on the platform host via the software; and
sending a confirmation message to the user computing device via the platform host.

13. The method of claim 12, wherein the message sent to the user computing device is SMS.

14. The method of claim 12, wherein the user authenticates a product via customer support, comprising;
on a platform host, establishing a communications link with a plurality of devices comprising a computing device and software;
executing the software on the computing device;
scanning, via the software, a user product serial number sent via email or other means to customer support;
displaying, via the software, on the computing device all of the product notes and attachments corresponding to the scanned product serial number.

15. A product authentication system, comprising:
a platform host in data communication with a plurality of devices and software including at least one or more computing devices and QR code applicators;
wherein the platform host is configured to receive data from the devices;
wherein the platform host is configured to store data from the devices;
wherein the platform host is configured to send data to the devices;
wherein the devices are configured to send and receive data from the platform host; and
wherein the devices are configured to execute the software.

16. The system of claim 15, wherein the software is configured to randomly generate a new QR code, send the QR code, via a computing device, to the QR Code Applicator for the QR Applicator to mark a product, and store the QR code in the platform host as a product serial number.

17. The system of claim 15, wherein the software is configured so that a user may register a product on the platform host with a computing device integrated with a camera.

18. The system of claim 15, wherein the software allows a customer service agent to scan the product serial number of a user's device to produce the personal data of the user and all of the user product's previous notes, as well as attachments to the notes.

19. The system of claim 18, wherein the customer service agent can add another product note with a single attachment.

20. The system of claim 16, wherein the QR code is marked on the product during production of the product to allow for production tracking.
